(19) United States
(12) Patent Application Publication
(10) Pub. No.: US 2014/0087797 A1
(43) Pub. Date: Mar. 27, 2014

(54) PHOTOGRAPHIC HIDE-AND-SEEK GAME FOR ELECTRONIC MOBILE DEVICES

(71) Applicant: Siddbetter Limited, (US)

(72) Inventors: KAPIL SIDDHARTH, NEW DELHI (IN); RAHUL SIDDHARTH, NEW DELHI (IN); WENDY CHAN, KILLARA (AU)

(21) Appl. No.: 13/873,428

(22) Filed: Apr. 30, 2013

Related U.S. Application Data
(60) Provisional application No. 61/704,250, filed on Sep. 21, 2012.

(51) Int. Cl. A63F 13/00

(52) U.S. Cl. CPC A63F 13/005
USPC 463/9

(57) ABSTRACT

Electronic game method and system where a hiding player hides objects in a background photograph. The hiding player can move, resize, rotate, crop, shade, and otherwise alter the object to better hide it within the background picture. The hiding player can also bluff by not hiding any new objects. One or more other players then receive the resulting image and try to select the objects that were not part of the original picture within a set number of tries. The game is played with electronic devices, ideally using smart phones or tablet computers equipped with touch screens and digital cameras. Players can use their own photographs to play the game.

### PRIORITY CLAIM

Applicants hereby claim benefit of U.S. provisional patent application 61/704,250, filed Sep. 21, 2012.

### FIELD AND BACKGROUND OF THE INVENTION

The present invention relates generally to the field of electronic games, and in particular to a hide-and-seek game where players take photographs using mobile devices and try to hide new objects in those photographs.

Analyzing paintings and making detailed observations is an art in itself. An observer viewing a work can analyze various aesthetic aspects of the image or work of art including its linear and aerial perspective, the placement of objects, the sense of depth and volume, its use of color (including warmth, range, and saturation), effects of light and shadows, and numerous permutations and combinations of the above. At the same time, an image, scene, or work of art may be analyzed from a more analytical, logical, detail-oriented perspective to try to determine things about the subject of the work and/or about the artist or photographer who created the work. A classic example of the use of logical deductions to analyze a scene is provided by Sir Arthur Conan Doyle's popular character Sherlock Holmes, who frequently used straightforward, practical principles to draw clever inferences based on careful observations. Today, it is not unusual to come across a “photograph” which has been carefully altered or “Photoshopped”® so that is it difficult to know if the picture accurately shows the original scene or not. People carefully examine photographs that they suspect have been altered to determine their authenticity, looking for subtle clues that something has been added or removed from the original.

At the same time, electronic games have gained tremendous popularity in the last several of decades, becoming a major form of entertainment, particularly among children, teenagers and young adults. Over the years simple single-player games have given way to far more complex games with many players, complex interfaces, and life-like graphics. In recent years, mobile electronic devices equipped with touch screens have emerged as an exciting new game platform, allowing multi-player games between distant people, using devices the players already own and carry for other purposes, and without requiring players to be playing at the same time. Many mobile devices come equipped with digital cameras, and taking and sharing photos between smart phones has become very popular. Similarly, internet social networks have emerged as a dominant digital-communication channel, and as a result games played on social network platforms can have hundreds of millions of users. Thus, there is a demand for multi-player interactive electronic games, particularly games for use with mobile device touch screens, with mobile device cameras, and/or with social networks.

“Find the Difference” is a well-known game based on the careful analysis of pictures. In a typical “Find the Difference” game, a Player is shown two side-by-side images with subtle differences between them, and must identify a number of variations between the two images to win the game. Electronic “find the difference” games using touch screens have found popularity as coin-operated pub games. Another game along the same lines “Which One is Different?” involves presenting the player a set of images which are all identical except for one, which is only slightly different. A player must identify which of the several images is different by making careful comparisons. The popular Where's Waldo?® books and games feature a particular cartoon man carefully hidden in crowded, busy scenes. Players search for the hidden “Waldo” character image among hordes of colorful characters. Other games where players try to find objects listed in a word or picture bank hidden in a picture are known in both hard-copy and online versions.

The above games have in common that they are normally provided as pre-fabricated games where the consumer only plays the “seeker” role, identifying differences in puzzles that are provided by the book publisher or game manufacturer. End-users of these games do not normally have the opportunity to create new games, such as by playing a “hider” role, or creating images and puzzles for their friends to analyze. Thus, a hide-and-seek image game where end users—including users without great artistic talent—can quickly and easily create games for other end users to play is desirable.

Another disadvantage of conventional “find the difference” type games is that once a player has spotted the differences between pictures, determined which image is different from the rest of a set, or found Waldo™ hidden among a throng of characters, that puzzle or that page in the book will no longer be challenging or interesting for that player. Thus, it would be advantageous to provide an image hide-and-seek game that this is not “used up” as players solve each puzzle.

The above games also have in common that once a difference between pictures or objects is noticed, or once the Waldo™ character or other hidden item is spotted, it is generally obvious that the player has indeed found what they were looking for, and the game is over. There is no need to closely analyze the possible difference, its context, or other subtle aspects of the image because, once the difference is first spotted, it is a simple matter to compare the different objects or drawings to confirm that the difference is, indeed, different. Similarly, once a player notices the Waldo™ character hidden in a drawing, no further analysis is necessary to complete the game. Thus, a hidden-image game that requires close analysis of possible hidden images, such as considering context, shadows, scale, and other subtle clues, is desirable.

U.S. Pat. No. 5,056,793 discloses a competitive picture identification game where players try to identify a partially concealed picture while progressively greater portions of the picture are revealed.

U.S. Pat. No. 8,162,760 discloses a method and apparatus for providing gaming services to remote game players.

U.S. Patent Publication No. 2012/0178527 describes a media recognition game which can be provided as a smart phone application with a graphical user interface. The game is provided on a smart phone application. The smart phone can download the application to play the media from the smart phone owner's device. In addition, the smart phone can be connected to a network interface for communicating with an online service such as the Google® Music, Rhapsody® or iTunes®. In operation, the application can retrieve media from the online service. In turn, a portion of the media can be played to the user. In one embodiment, the media can be altered, for example, providing just lyrics or just music. The user can then provide, to the best of their ability, an identifier for the media. The application can determine whether the user's identifier is correct and display a proper message thereafter.

### SUMMARY OF THE INVENTION

It is an object of the present invention to provide a pictorial hide-and-seek game where players create puzzles for other players to solve. It is a further object of the present invention to provide a game specially suited to mobile devices equipped with digital cameras touch screens and/or for use with social networking internet sites and photo hosting internet sites. It is also an object of the invention to provide a game where players can match their skill in photo editing against their ability to carefully analyze photographs.

Accordingly, a general concept and preferred embodiments of an electronic pictorial hide-and-seek game where digital objects are hidden in real-world photographs is herein disclosed.

The electronic game of the present invention is an improvement on the prior art pictorial searching games such as those described above. In a typical “Find the Difference” game, a Player is displayed 2 images side-by-side with subtle variations and is asked to identify a certain number of variations in the two images. This new game is more challenging and interesting on several levels, such as by having players create and hide images as part of the game, and by adding competitive and artistic aspects to the game. The new game is also more interesting because it asks players to identify “hidden” images without the opportunity to compare the original image. Players must find hidden objects based on context and subtle hints in the new image, or else must determine that all the objects in the drawing are original.

The game is played between two opposing players, usually in a social environment. Picture games, puzzles, trivia and other games that involve the use of common sense always raises great interest amongst members of our society, as they provide a form of entertainment as well as intellectual stimulation. Furthermore, the desire amongst members of society to strive for a positive self-concept provides further motivation to play such games in social settings.

This type of game has been technically and commercially possible only in recent years because it requires the following:
1. Computational power to perform image manipulation in real-time using standard consumer electronics;
2. Widespread availability of digital cameras, especially digital cameras embedded in mobile personal electronics; and
3. Widespread internet access so that players' devices can communicate easily with each other and with digital hosts.

This game is ideal for playing electronically because it involves the manipulation of images, especially photographs, by players. The development and implementation of this game has only recently become practical due to developments in technology and to widespread social interaction over the internet. The processing power of “smart phones” has increased in tandem with the rising speed of 3G and 4G data networks. Many new mobile electronic devices, such as tablet computers and smart phones, are equipped with cameras and have internet connectivity, making them ideal game devices for the invention described herein.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which selected preferred embodiments of the invention are illustrated.

### BRIEF DESCRIPTION OF THE DRAWINGS

In the drawings:

FIG. 1 is a diagram of a possible relationship of devices, users, and a host for implementing the game;

FIG. 2 is a block diagram of an electronic device for use with the game;

FIG. 3 is a block diagram of a server for use with the game;

FIG. 4 is a flow chart showing an example game play sequence;

FIG. 5 is a simplified user interface for a player home screen;

FIG. 6 is a screen displayed to a player for selecting a Base Image for creating a resulting game;

FIG. 7 is a hider's game screen including a Base Image and buttons for adding Odjects and sending a finished resulting game to a finder;

FIG. 8 is a hider interface for selecting Odjects to add to the Base Image, and three additional exemplary Odjects which could be used in the interface;

FIG. 9 is a hider's game screen showing an Odject being rotated with respect to the Base Image;

FIG. 10 is a hider's game screen showing an Odject being resized;

FIG. 11 is a hider's game screen showing an Odject being repositioned on the Base Image;

FIG. 12 is a hider's game screen showing an Odject being flipped over horizontally;

FIG. 13 is a hider's game screen showing an Odject being flipped over vertically;

FIG. 14 is a hider's game screen showing a Base Image and three Odjects hidden within the Base Image;

FIG. 15 is a transformed resulting game;

FIG. 16 is a seeker's game screen;

FIG. 17 is a seeker's game screen after one of three hidden Odjects has been identified; and

FIG. 18 is a result display at the conclusion of a game.

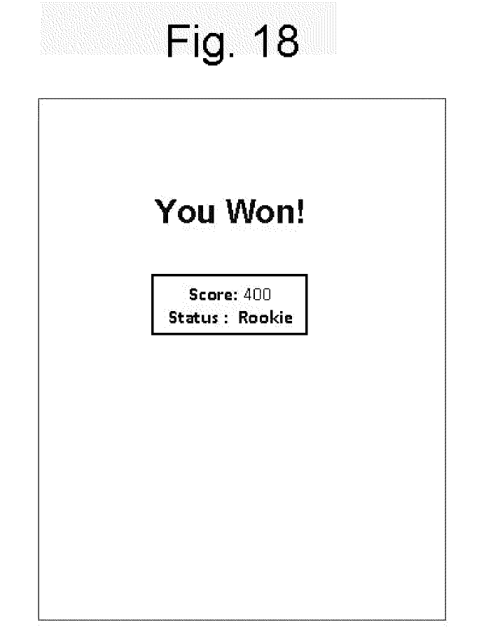

### DESCRIPTION OF THE PREFERRED EMBODIMENTS

The game of the present invention typically involves a first “Hider” or “Hide Player” player selecting a picture, adding one or more objects—which may be called “Odjects”—to the picture, manipulating the added objects to make them less conspicuous, and then sending the resulting puzzle to a second “Seeker” or “Seek Player” player who will try to identify the hidden objects that were not part of the original picture within a set number of turns.

The invention provides a novel picture game to be played by two or more opposing players in a competitive setting. The rules of the game have been constructed so as to offer players social entertainment through continuous mutual interaction and intellectual stimulation. This game involves the use of common sense, critical reasoning, strategy and observational power (such as the ability to perceive subtle variations in perspective, shadow, lighting, and color). At the same time, players can get extra enjoyment from a game based on pictures of people and places that they know.

The rules of the game are designed to offer players social entertainment featuring competitive interaction and intellectual stimulation. The game involves the use of common sense, critical reasoning, strategy, and observational power. Players' ability to perceive and to manipulate subtle variations in perspective, shadow, lighting, and color are important to success in the game. Players develop their critical reasoning and logical thinking abilities. Players have an opportunity to improve their observational powers, and at the same time to learn about the basics of fine arts, in a fun and intellectually stimulating environment. In preferred embodiments players can hone their skills as a photographer, as an artist, and/or as a digital image editor.

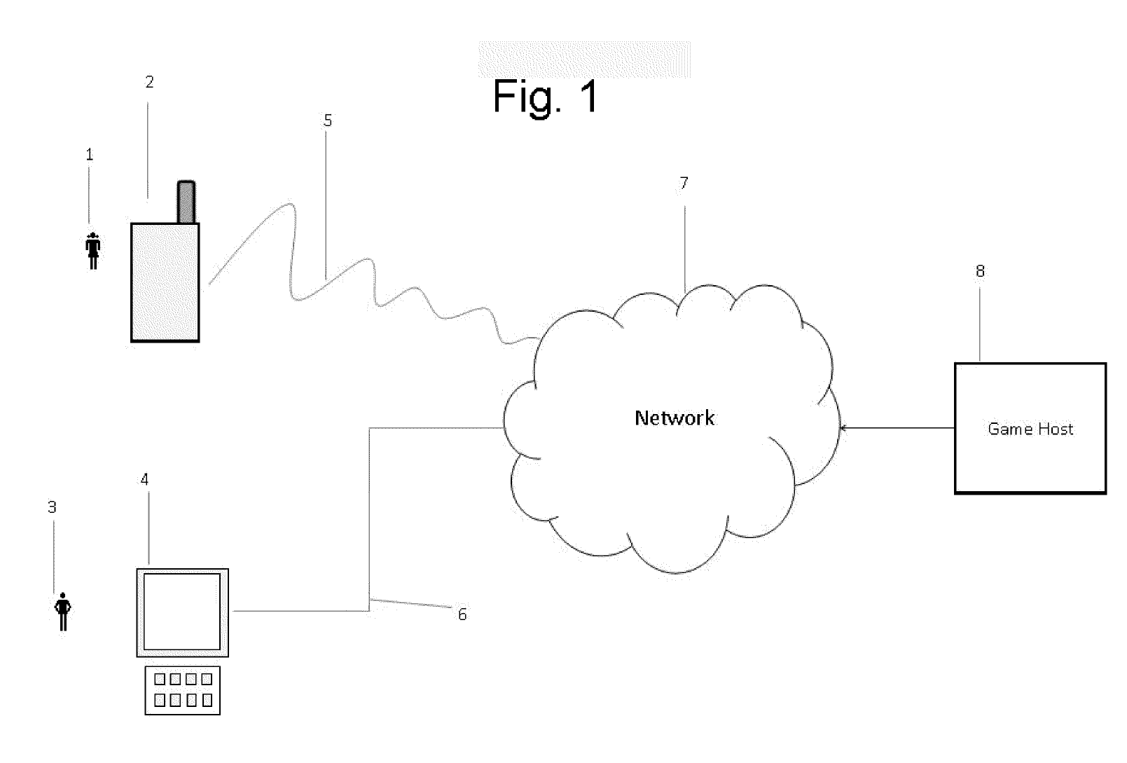

Referring now to the drawings, in which like reference numerals are used to refer to the same or similar elements, FIG. 1 shows a simplified diagram of a system in which a preferred embodiment of the invention can be carried out. The arrangement depicts two players 1, 3 who are each operating a different respective device 2 and 4. In this embodiment the first player 1 is using a mobile phone device 2 which communicates wirelessly with a network 7, and the second player 3 is using a desktop computer 4 which is connected to the network 7 by wire or cable means 6 such as DSL, cable modem, or any other means. FIG. 1 shows that each gaming device is arranged to communicate through a network 7 with a game host 8, although other arrangements are possible. The game host is preferably arranged to manage or facilitate the game play and store data. Each of the gaming devices can communicate over wireless 5 or land line 6 link with the network 7.

The game can be played between different types of devices, such as a Mobile 2 to Computer 4, Mobile to Mobile or a PDA to Mobile. Many devices can be used as gaming units including, but not limited to, smart phones, tablet computers, electronic readers, laptop computers, desktop computers, PDAs (Personal Digital Assistants), video game consoles, internet-enabled televisions, or other technologies now known in the art or yet to be invented.

The gaming host 8 is separate from the gaming devices in a client-server model such as the embodiment in FIG. 1. However, the game host function can be provided by one of the gaming devices if most or all of the game logic is transferred to that device. The gaming devices in such a system can interact with one another in a peer-to-peer network arrangement, rather than in a client-server relationship. A client-server arrangement is preferred because it facilitates easy interaction and playability. Alternatively, the entire game could reside on a single personal device that is passed between players between turns.

In a most preferred embodiment, each gaming device 2 is able to take pictures, to communicate over the network, and to interface with the user. Camera phones, smart phones, and tablet computers with an embedded or attached camera are ideally suited to act as a gaming device in the present invention.

Nevertheless, an embedded camera is not essential in order for the device to act as a gaming device because digital images from any source can be used. If the gaming device is able to download an image from an external device such as a camera or scanner, or to select and/or download an image from the internet, then the device can act as a gaming device for the purposes of this invention. Images stored on a hard drive, CD-ROM, external drive, flash drive, or any other source can be used as base images and/or as Odjects.

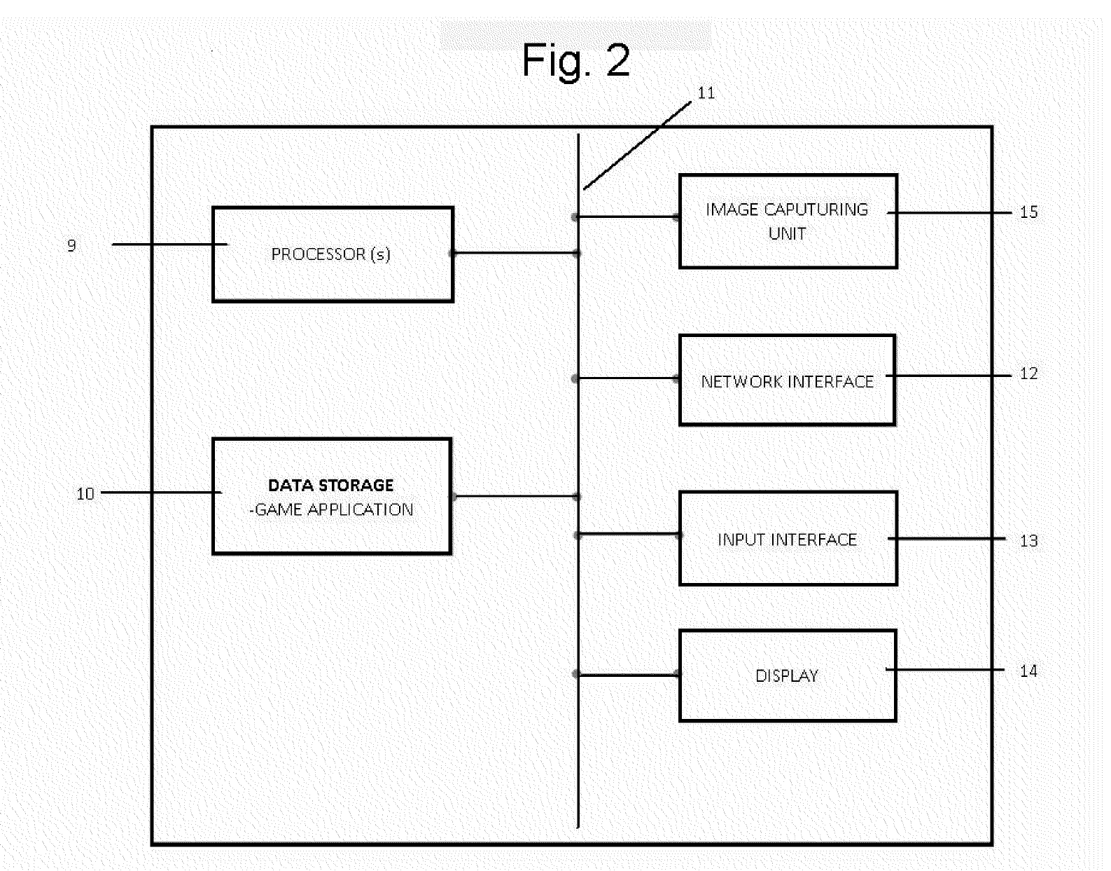

FIG. 2 shows a simplified block diagram of a representative Gaming Device including functional components that a preferred device could include. As shown, the device includes one or more processor(s) 9, data storage 10 (which can include volatile and/or non-volatile memory), an image capturing unit 15 (such as a camera), network interface 12 (such as an internet connection), display 14 (such as a computer monitor or touch screen), and an input interface 13 (such as a computer mouse or a touch screen). All of these components can be coupled together by a system bus 11 or other by mechanisms. Typically the data storage holds program instructions executable by processor(s) to carry out various functions as described in the game logic. Alternatively, this function can be carried out in other ways, such as by firmware or hardware.

What data storage and processing is done by a user's gaming device vs. by a host or other means can vary between embodiments. As discussed elsewhere, embodiments where the game exists entirely on user devices, entirely on an internet site, or other variations are possible.

In a most preferred embodiment, some of the application logic is stored in each gaming device. The application logic stored locally on each gaming device will be referred to as the Native Application. This arrangement provides for faster processing and smoother user interaction.

It is not, however, essential that the gaming device store application logic. In alternative embodiments the game logic may reside entirely on a game server, with the server communicating with the gaming devices in a client-server model, and the game being played through a web browser client. The game could also be entirely hosted on an internet site that players can access from any computer, mobile or otherwise. The game could be an application integrated into another internet site, such as a social networking site.

### Game Server

In the preferred embodiment, the game server is the core intelligence of the game host. As such, the game server maintains information such as player data, photos, Odjects, user profiles, game results, and other gaming data to manage and facilitate the game play.

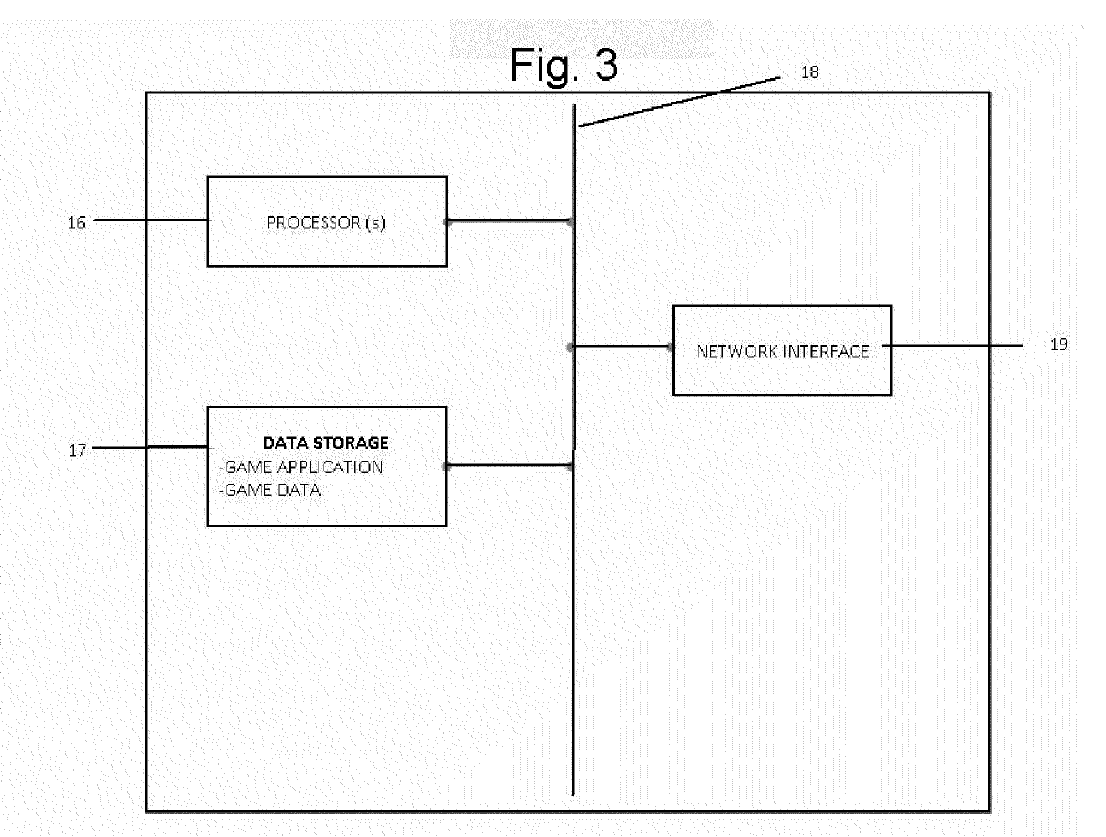

FIG. 3 shows a simplified block diagram of a game server. To carry out the functions described above, the game server preferably includes a processor 16, data storage 17, and a network interface segment 19. These components maybe coupled together by a system bus 18 or by other mechanisms.

The game server may communicate with the gaming devices in any agreed protocol, either proprietary or standard. For instance, the game server and the gaming devices could communicate according to the HTTP or HTTPs. Each gaming device can include an HTTP Client (which can be a native application or web browser), and the gaming server could include an HTTP server application. The game server and gaming device can then interact with the HTTP server through conventional HTTP messaging.

### Game Play

As outlined above, the present invention comprises an interactive game between two or more players where a Hider player generates a puzzle by modifying a picture, and then sends the puzzle to an opposing Seeker player, challenging the Seeker to identify the modifications within a certain number of attempts.

A simple embodiment of the game consists of two opposing players: one player taking on the role of “Hider” while the other takes on the role of “Seeker.” Embodiments with different player roles are also possible. A given puzzle might be sent to multiple Seekers. Multiple seekers could compete to find all the hidden Odjects in the fewest tries or in the shortest time. More than one player could be involved in the Hiding step as well. For example, multiple Hiders might be assigned the same set of Odjects and the same base picture, each being challenged to hide the Odjects more effectively than the other Hider. Hiders can compete against each other to stump Seekers using the same or different base pictures and Odjects with varying levels of difficulty.

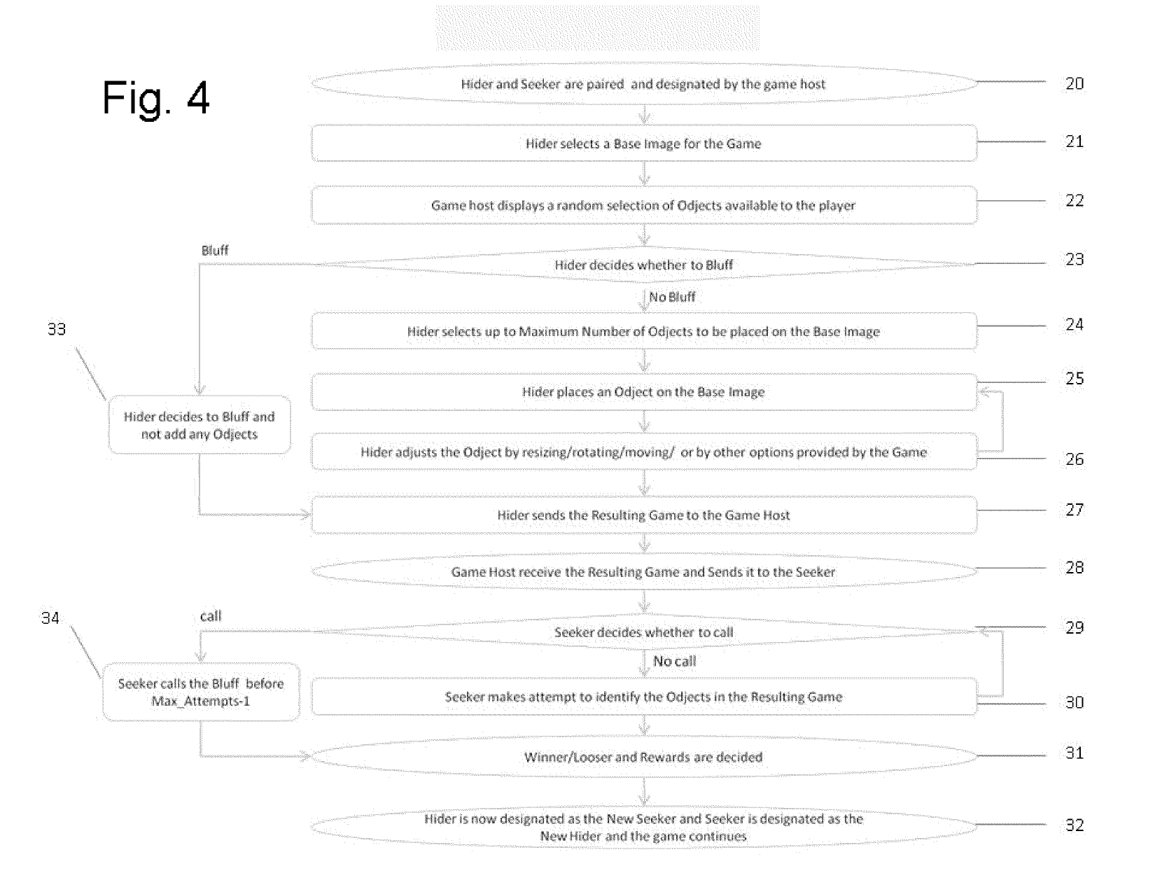

By way of a non-limiting example, the following sections will describe the operation of a hypothetical game as outlined in FIG. 4.

In a typical game, the player designated as the “Hider” will select or be assigned an image which will the “Base Image”. The Hider then makes one or more modifications to the Base Image. When the Hider is finished the resulting game or puzzle is then sent to the game host, which in turn sends the game to the “Seeker”. The “Seeker” will have to identify any modifications—typically added Odjects—in the image within a certain number of attempts to win the game. Once the “Seeker” has completed their part of the game, the result of the game is displayed at the Seeker's device. The result is also sent to the game host, which then notifies the Hider of the result as well. Often the two players then exchange roles with the Hider being re-designated as the Seeker, and the Seeker being designated as the Hider, for the subsequent game.

### Game Initiation

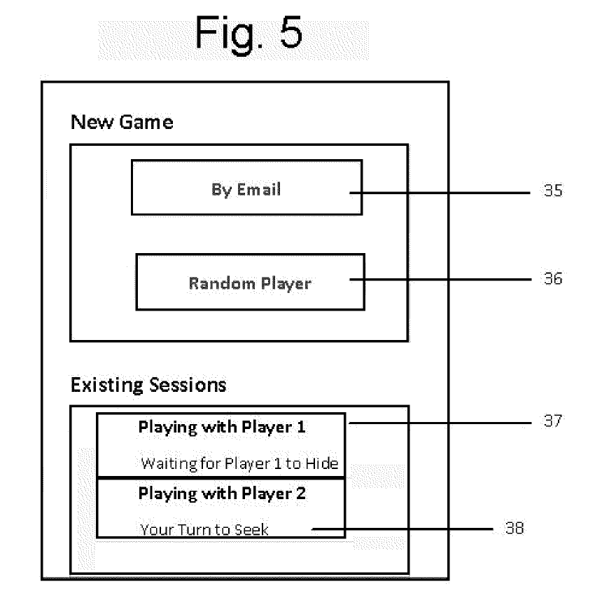

As shown in FIG. 4, the game is initiated when the game host pairs up two players together and designates them as a Hider and a Seeker, as shown in Step 20. FIG. 5 shows a simplified user interface for a Home Screen of a player. In this example, the game will be initiated when a player creates a new game from the home screen by selecting “By Email” 35 or “Random Player” 36 buttons.

Player pairing may be done by the game host. The host may pair available Hiders and Seekers randomly, from lists of players looking to play a game, or otherwise. For example, a player could ask the game host to randomly assign an opponent by selecting 36.

The Hider and the Seeker may choose each other. This might be accomplished such as by simultaneously agreeing to play a game, or by one player sending, and the other accepting, an invitation to play a game. A game can be initiated by one player providing some identifier of the desired opponent to the game host (e.g. an email address), such as by selecting 35. The initiating player could also select an opponent from a list of connections on a social networking site, from a list of contacts such as phone or email contacts, and/or from a list of acquaintances that already have the game on their devices or that have signed up to play the game on a website.

In one preferred embodiment the host assigns the role of Hider to the player initiating the game by default. This is advantageous when players are not playing simultaneously because the initiating player, as the Hider, can create a puzzle which the other player (who becomes a Seeker) receives at the same time they receive an invitation to play a game, which might be hours or days later. It is possible for a Hider to initiate games with multiple Seekers by sending them the same puzzle. In the case where there has been a request for a random opponent, the designation of Hider or Seeker may be done randomly. In another embodiment of this invention, the Hider and Seeker role can be assigned randomly by the Game Host irrespective of the mode of initiation of the game. In a further embodiment, players seeking a random opponent can specify that they want to be a Hider or that they want to receive a puzzle and be a Seeker.

### Hiding

### Creating a Puzzle

Once a game is initiated, the Hider may select a Base Image as shown in step 21. The Base Image is any background image that is used by the “Hider” as a part of the game to make a Hide as described below. Ideally the image will be a real-life image taken by the player: e.g. an image of a street if the player is outdoors or an image of interior of a house if the player is indoors.

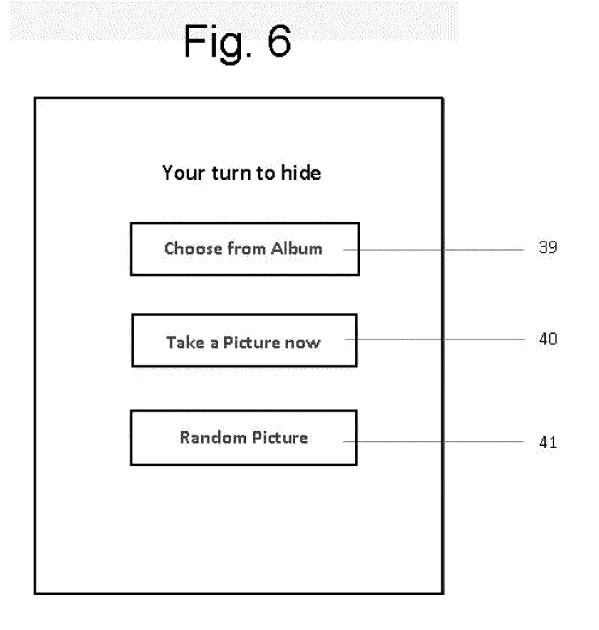

Depending on the game device and the embodiment of the game, the Hider will be given various options to select the Base Image. FIG. 6 shows an example of the screen displayed to the Hider for selecting a Base Image when the game device is a camera phone. The Hider can select an existing image from an album, such as a pre-existing image taken and stored by the camera phone, by selecting 39. In the embodiment in FIG. 6 the Hider can also take a new picture to use as a Base Image by selecting 40, or use a random picture provided by the game host by selecting 41. In other embodiments the options available to the “Hider” in selecting a Base Image can be expanded to allow use of a “URL (Uniform Resource Locator)” to get a Base Image from a specific location on the internet. Alternatively, the players may be able to find and select Base Images by a normal internet search, from a social networking site, from a photograph hosting site, or from a web page stocked with background scenes intended for hiding. Alternatively, the Base Image may be assigned to the Hider or chosen at random. Preferably the Base Image is a photograph, although embodiments using artwork, drawings or other images are also within the scope of the invention.

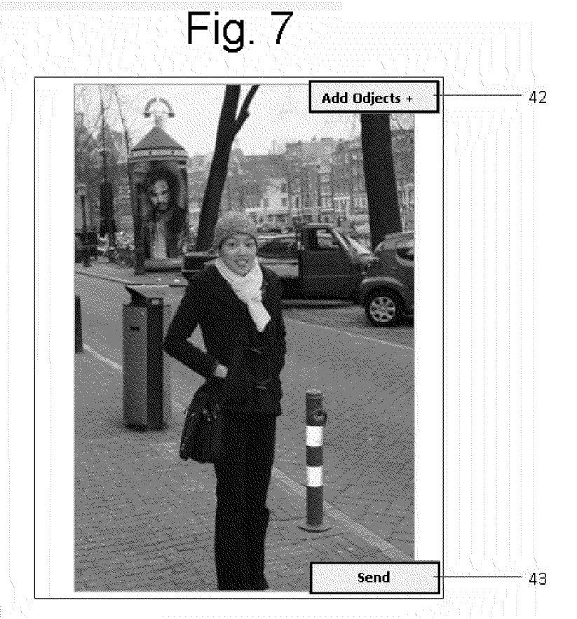

After the Base Image is selected, the hider is taken to a screen to modify the Base Image to create a puzzle. FIG. 6 shows a Hider's Game Screen. The Player can select 41, which will take him to a user interface to select Odjects as shown in FIG. 7. The game host then displays a selection of Odjects available to the Hider, as shown in step 21 and FIG. 7. Odjects can be stored as a part of the game native application on the device itself and/or can be provided by a game server.

For the purposes of this invention, Odjects refer to images that are provided for hiding as part of the game. They typically are a solid object (i.e. a mailbox) on a transparent background, which allows them to be placed on a Base Image with a seemingly better fit. The game apparatus preferably has a large number of available Odjects that can be used by the players. Each object for hiding is called an Odject, and they are collectively known as Odjects. Odjects can be real-life images or may have been constructed artificially. The Odjects may consist of one object or multiple objects. They can be living, non-living, real or artificial. Animals, plants, signs, vehicles, tools, people, food, toys, books, consumer electronics, eating utensils, writing utensils, and appliances are non-limiting examples of possible Odjects. Odjects will typically be photographic images, although artwork or other images may be used in alternative embodiments.

In a preferred embodiment the Hider is presented with a random assortment of Odjects. In another embodiment of the current invention, Odjects can be also be added by a player, or can be provided via a third party such as a sponsor. For example, a food and beverage sponsor might pay to have its products provided as Odjects, or a player might create Odjects by “cutting” them out of photographs. Added Odjects can be provided as rewards for player achievements playing the game, or purchased for real or virtual currency.

In a preferred embodiment sets of Odjects appropriate for a particular type of scene are selected or provided. For example, there could be sets of beach Odjects, kitchen Odjects, street scene Odjects, sports Odjects etc. appropriate for hiding in different types of Base Images. Pre-matched Base Images and Odject sets could be automatically provided for a Hider to use. Alternatively, a Hider might have an option to select a set of Odjects appropriate for a Base Image they have selected—i.e. selecting a set of beach Odjects to hide in a picture they took of a real-life beach scene.

Alternatively, the players may be able to find objects to hide by a normal internet search, or from a web page stocked with Odjects intended for hiding.

As shown in step 23 in FIG. 4, the Hider needs to determine whether he wants to add any Odjects to the Base Image. In a preferred embodiment of the game, the Hider has the option not to hide any Odjects. If the Hider decides not to place any Odjects on the Base Image, this is known as a “Bluff”. Preferably the Hider can make the decision as to whether or not they want to add any images to the Base Image at any time prior to sending the Resulting Game File to the game host, as explained below.

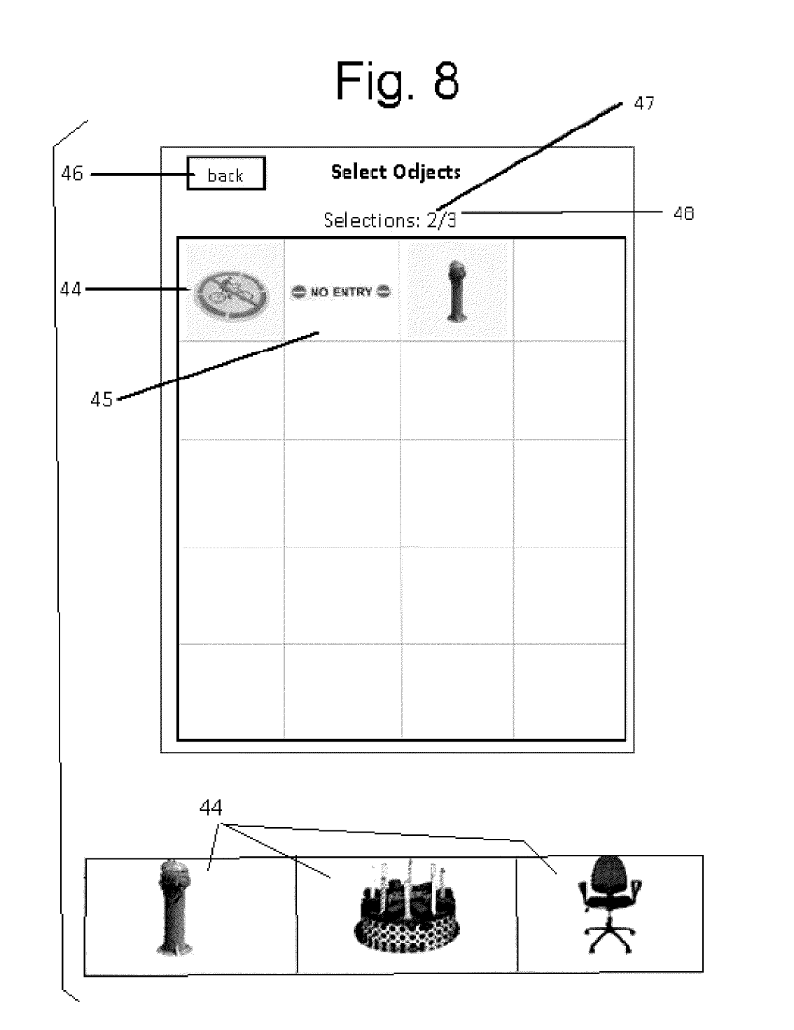

FIG. 8 shows a Hider interface to select Odjects. The game host displays a selection of Odjects such as examples 44 and 45. A Hider might be required to hide all objects provided, or allowed to pick a few from a large selection of Odjects. The Hider can go back to view the Base Image by selecting “back” as shown in 46. The Hider is shown selected objects as in 47 and Maximum Number of Odjects they can hide 48. In a preferred game the Hider can select up to a Maximum Number of Odjects (decided by the game host) to be placed on the Base Image, as shown in Step 24. The Hider selects an Odject and then returns to the Base Image by selecting “back” as in 46.

### Odject Adjustment

As shown in FIG. 4, Step 25, the Hider places a selected Odject on the Base Image. As in Step 26, the Hider then resizes, rotates, moves, flips, crops, and/or otherwise manipulates the Odject(s) so as to make them look like a part of the Base Image. A variety of tools and options for hiding the Odjects can be provided, including but not limited to those typically included in picture editing programs. This hiding and manipulation is a challenging and interesting part of the Hider's role, and is an important element differentiating this invention from prior art games.

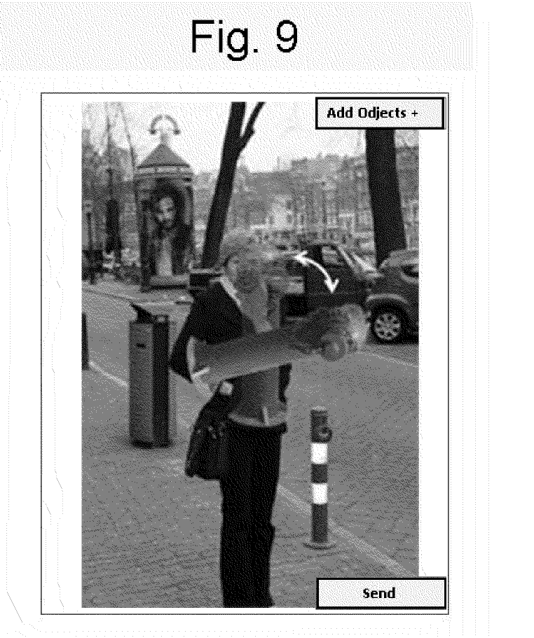

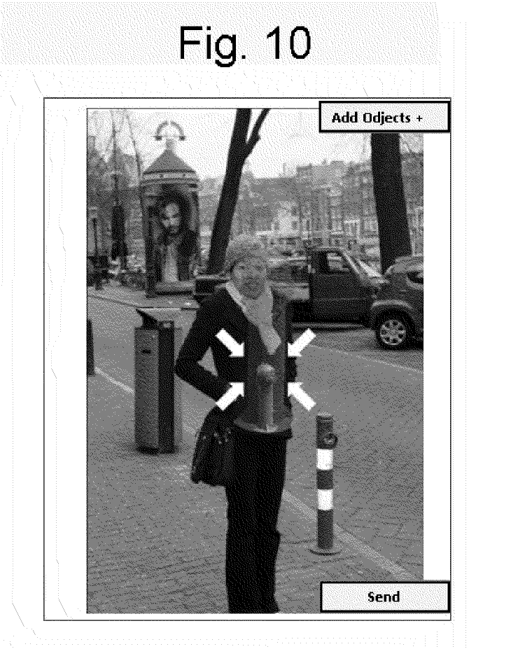

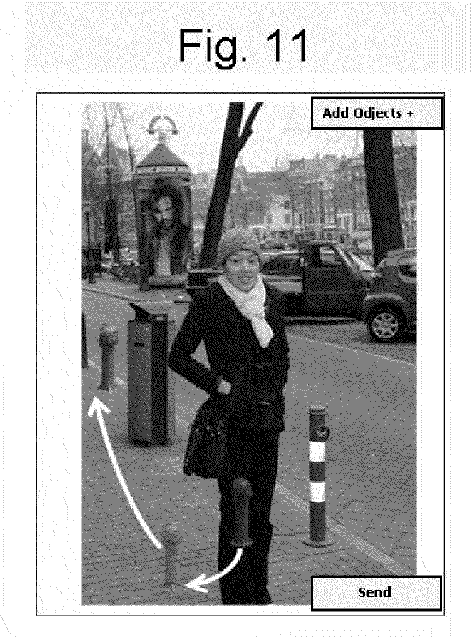

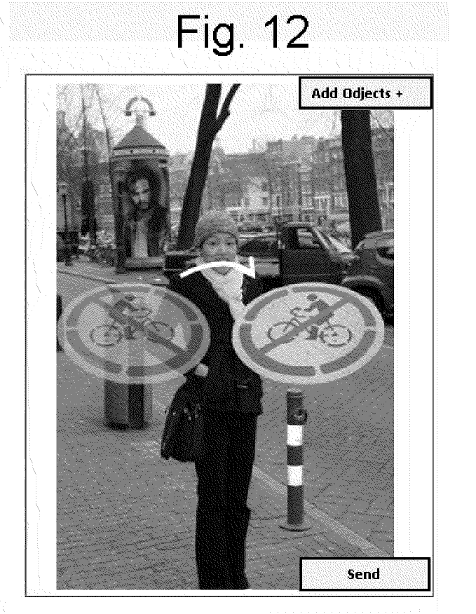

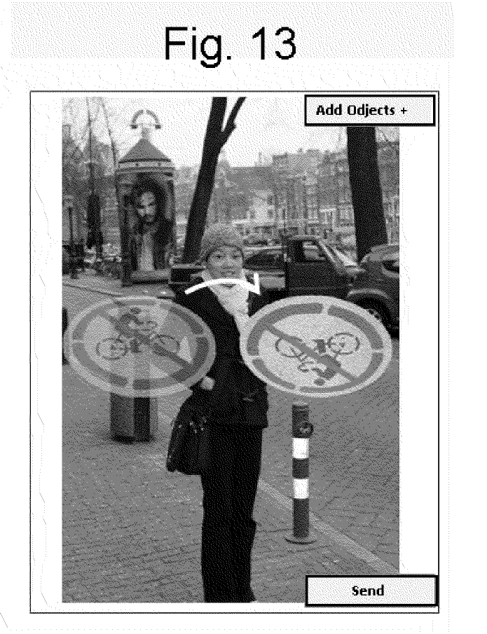

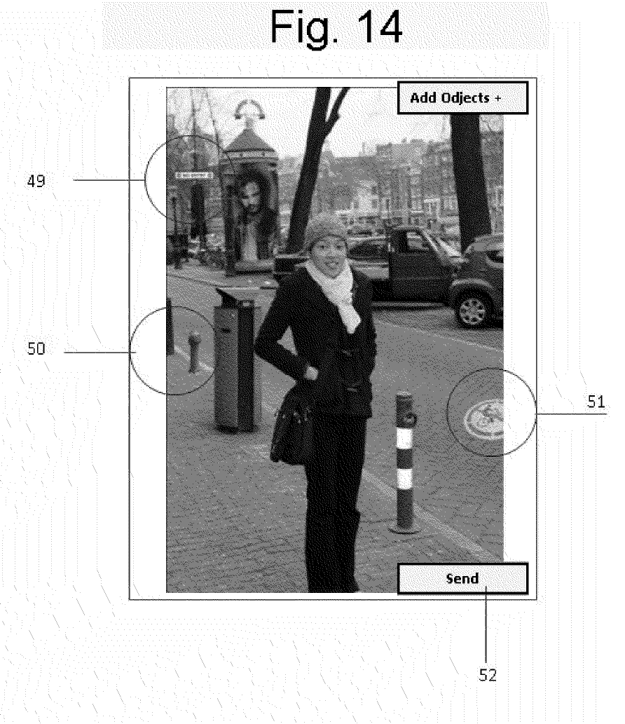

FIG. 9 shows an Odject being rotated. FIG. 10 shows an Odject being resized. FIG. 11 shows Odject being moved. FIG. 12 shows Odjects being flipped horizontally. FIG. 13 shows Odjects being flipped vertically. FIG. 14 shows the final placed Odjects.

Preferably there are limits on what the Hider can do to hide the Odjects so that the Seeker has a reasonable opportunity to find them. For example, in a preferred embodiment, the size to which an Odject can be reduced is limited to a set fraction of the original image or a set absolute size (“Minimum Size”). This is to ensure that the Odject is not made so small as to be not visible to the Seeker of the Hide. The game displays the selected Odject on the top, thus enabling a player to hide one Odject behind another and make them appear concealed behind another Odject. The Hider might be allowed to crop only a set percent of each Odject in hiding it, be limited in how much shadow can be applied to the Odject, or otherwise limited in there interests of fairness.

In the most preferred embodiment of the present invention, the gaming device will comprise a touch screen user interface. Some examples of preferred devices include Apple's® iPad® and smartphones such as Apple's® iPhone® or Android® phone devices. Touchscreen user interfaces allow Hide players to resize, rotate and move the images in response to various touch gestures performed by the Hide Player. Other interfaces such as computer mouses, touch pads, video game controllers, and keyboards can also be used depending on the gaming device. The invention is not limited to any particular device or interface type.

In a preferred embodiment of the current invention, a variety of adjustments can be performed on Odject images. These preferably include scaling, rotation, moving (also called “translation”), vertical and horizontal flipping. Such adjustments may be, but do not have to be, performed using affine transformation.

Additional tools can provided to enhance the ability of Hider to make the Odject appear to be a part of the Base Image. Such tools could be manual, requiring some artistic ability by the Hider, or could be automatic. Examples of such tools are tools for adding shadows to Odjects, for cropping Odjects, or for drawing on the Base Image and/or Odjects.

A tool to add shadow might add a fading black border to the contour of Odjects. The direction of the shadow might be decided by the player depending on the perceived source and direction of light in the Base Image. A tool to crop the Odject, either automatically or in a free form, might allow the image to appear partly concealed behind another object in the Base Image. Tools could also be provided to allow players to lift or cut Oddjects out of pictures of their choice for use in the game.

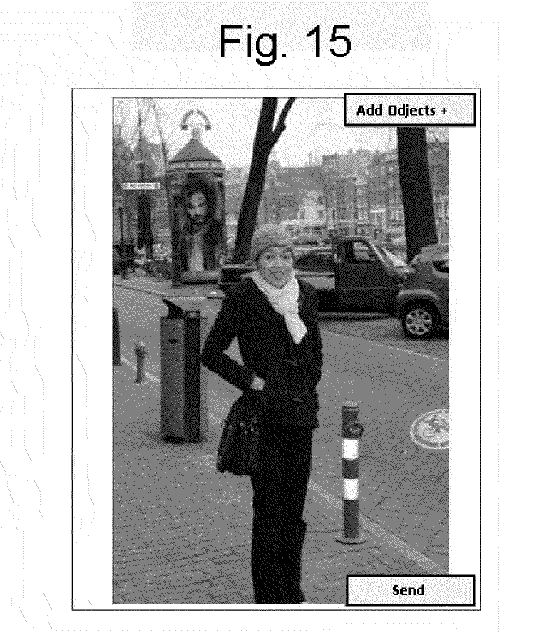

Typically the Hider can take as much time as needed, and can perform as many adjustments as desired, before sending a completed Resulting Game to one or more Seekers. The Resulting Game refers to a set of game data describing the puzzle created by the Hider, and comprises metadata and the Game Image created by the hider from the Base Image and any added Odject(s) and/or other modifications such as drawing and shading. The Game Image is the image actually shown to the Seeker during the Seeker's turn. The Hider can alternate between different screens, such as a user interface for selecting Odjects (FIG. 8) and Hider's Game Screen (FIGS. 7 and 9-15), until they are satisfied with the Resulting Game.

As shown in FIG. 4 Step 27, once the Hider is satisfied with the placement of the Odjects, he requests that the Resulting Game be sent to the game host by selecting “send” as shown in 52, FIG. 14. In various game embodiments the Resulting Game may be sent directly to a Seeker, sent to a host, saved on an internet site, or saved locally.

### Puzzle Image Transformation

A photographic Base Image used by the Hider may be substantially different from the hidden Odjects with respect to qualitative visual elements such as color tone, saturation, brightness, etc. Use of different cameras and camera settings, differences in lighting at the time and place the respective pictures were taken, and other factors may cause the Base Image picture to look different from the Odject(s) if the Odjects were taken out of other larger photographs.

As such, a transformation may be performed on a Resulting Game after Odject(s) are added to the Base Image to assist the Hider to make the Odjects look like a part of the Base Image. Such a transformation may be performed on the entire picture (Base Image, added Odjects, any shading etc.), or only on new content added to the Base Image.

For example, a transformation process might reduce the saturations in a finished picture, or alternatively make saturation more uniform throughout the final picute. Alternatively, other image transformations might be applied to adjust the Odjects and Base Image to make Odjects appear as a part of the Base Image. Such transformation can include making the Base Image and Odjects black and white, applying shadows to the Odjects, changing the lighting of the Base Image, matching the histogram of the Odjects to that of the Base Image, and/or other transformations. Such transformations could be applied automatically by the game application, or could be applied by a Hider player who controls what transformations would be applied to the Base Image and Odjects.

An open source library such as Image Magick (and its extension for the respective client) can be used for performing such transformations.

### Seeking

### Finding the Odjects

The game application sends the Resulting Game information out, typically to the game host or directly to a Seeker, once the Hider indicates that they are done making their hide or their bluff. The Resulting Game information typically includes information such as detail about the Base Image file, selected Odjects, placement and transformations applied by the Hider to the Odjects, metadata, and information about the Hider and Seeker. The Resulting Game data may include a Game Image, or may contain information that can be used to derive the Game Image at the host or the Seeker's device. The Resulting Game Information is provided in a format pre-agreed between client on the gaming device and the game server.

In a preferred embodiment the game host stores the Resulting Game Information in its database when it receives it. When the Seeker logs into the application, a request is sent to the game host for updated game information. The game host then sends the Resulting Game to the Seeker's device, as shown in Step 28. Embodiments where the Resulting Game information is automatically pushed to a Seeker's device, or where the Seeker simply views the game on an internet site, are also possible.

The Seeker may be shown a list of pending game sessions such as the one shown in FIG. 5. In this example, the Resulting Game may appear as in 38 on the Home Screen, indicating that a Resulting Game is available for the Seeker to view and play.

The image shown to the Seeker is called the Game Image. The Game Image will typically include the Base Image, Oddjects and other modifications (if the Hider hid Odjects) or just the Base Image (if the Hider chose to bluff). The Seeker is typically given a certain number of attempts (“Maximum Attempts”) to identify the Odjects (an “Identification Event”) in the image. Depending on the device used by the Seeker to play the game, they can identify the Odjects in the Game Image by touching or tapping the Odject, by clicking using a mouse cursor, or any other indication method that may be developed for electronic devices available now or in the future.

As noted above, the Resulting Game information includes stored information about the game made by the Hider including the Base Image, and the coordinates, size, affine transformations, and other details about the Odjects that are placed on the Base Image. Preferably when an Identification Event is executed—such as a Seeker tapping a spot on the Resulting Game picture—the native application notes the coordinate of the Identification Event and calculates if the coordinates are within the contour of the Odjects that are stored in the Resulting Game. If multiple Odjects are stacked in the position that is tapped or clicked, the native application records the first Identification Event as identification only of the Odject that is placed on the top. The Odject that is placed on the top is determined by the order in which Odjects are placed by the Hider. Typically, if multiple Odjects are placed on same coordinates, the Odject placed later in time is shown on the top of the others. Once an Odject has been identified, it is preferably removed from the view and the Seeker continues as above. In some embodiments the screen visually indicates the location the game believes an identification event has occurred and/or will occur if the Seeker takes a certain action such as tapping the screen or clicking a button.

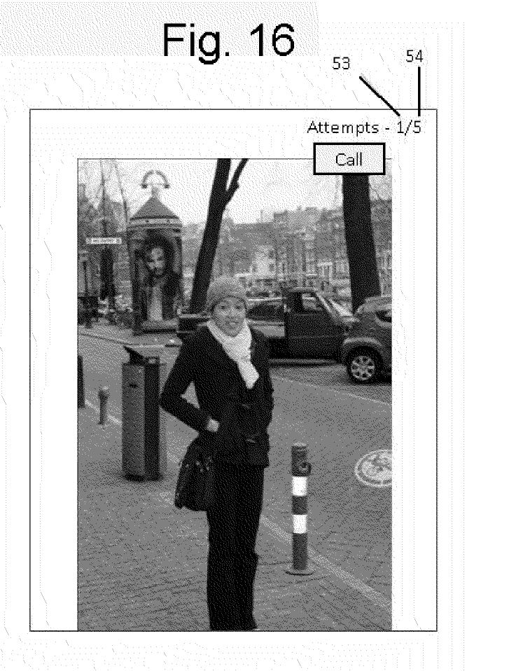

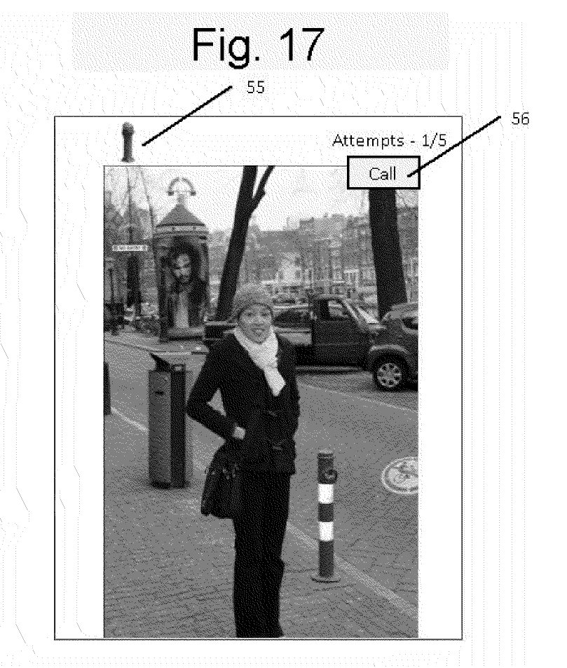

FIG. 16 shows a Seeker's Game Screen, and FIG. 17 shows the Seeker's Game Screen with an identified Odject. FIG. 17 shows the number of attempts used thus far as in 53, as well as the Maximum Attempts available as in 54. Upon identification of an Odject, the Odject is removed from the Resulting Game and displayed separately as shown in 55. The invention is not limited to any specific method of counting the number of identifications attempted or available.

If the Seeker believes that Hider has played a Bluff, then the Seeker can call the Bluff by selecting 56 as in step 34.

A typical game ends when the Seeker identifies all Odjects, when the Seeker calls a Bluff, or when Seeker has utilized all available identification attempts. Variations are possible where an incorrect “bluff” call ends the Seekers' game unsuccessfully, where the incorrect call merely counts as a failed identification attempt, or where bluffing is not allowed. Once the game is finished, the Seeker is shown the result of the game and any rewards, as shown in step 31. The game application may send the result of the game to the game host along with other details of the game such as information about the Hider, Seeker and game details. The game host then sends the result to the Hider. Alternatively, the results may be sent directly to the Hider, or may be viewed by the Hider the next time they log on to an internet site hosting the game.

Typically game host suggests a new game designating the Hider as the new Seeker and the Seeker as the new Hider, and the game continues such as by returning to step 20 or 21.

### Scoring and Rewards

A variety of scoring and rewards systems can be used with the type of electronic hide-and-seek games disclosed herein. An example system is described herein to provide an illustration of how the winner can be decided, how the winner might be rewarded, and how Bluffs could he scored, but the example is intended to be non-limiting.

Each game in the example system has the following parameters:
Maximum Number of Odjects that can be added by a Hide Player to a Base Image (Max Odjects)
Maximum Number of attempts that a Seek Player can use to identify Odjects or Bluff (Max Attempts), wherein
Max Attempts>=Max Odjects

The number of attempts available must be at least as high as the number of Odjects to be found. Alternatively, a system where the seeker is allowed a set number of wrong guesses can be used.

### i. No-Bluff Scenario

In the case where the Hider chooses a no-bluff strategy, the Hide Player hides up to the Max Odjects number of Odjects on the Base Image. If the Seek Player is not able to identify all Odjects in, for example, 5 attempts, he loses the game and the Hider is awarded points. If the Seeker does identify all Odjects in the allotted turns the Seeker is awarded points and the Hider receives no points.

In one embodiment of the game, the lower the Number of Odjects hidden by the Hider, the greater the payoff for the Hider if the Seeker does not identify all the Odjects within the allotted turns. For example, if the Max Odjects for a game is 3, and Max Attempts for the Seeker is 5, the point payoff for the Hider for winning the game—meaning the Seeker did not identify all the Odjects—might be as follows:
Hide Player hides 3 Odjects: 12 Points
Hide Player hides 2 Odjects: 14 Points
Hide Player hides 1 Odjects: 16 Points

The Seek Player has up to the Max Attempts to identify all the Odjects in the picture. Thus, it is harder for the Hider to avoid the Seeker identifying all the Odjects in Max Attempts turns if fewer Odjects are hidden while Max Attempts remains constant. In this example the pay-off for the Seek Player remains at 12 points irrespective of the number of Hides (hidden objects) used by the Hider. Alternatively, a Seeker might be awarded extra points for identifying all Odjects with additional attempts remaining.

### ii. Bluff Scenario

In preferred embodiments of the game, the hider has the option to Bluff. In the case of a Bluff, the Hide Player hides no Odjects on the Base image. The Hider hopes that the Seeker will waste their allotted Max Attempts trying to identify non-existent Odjects before guessing that the Hider has, indeed, Bluffed.

In the example embodiment, the Hider wins a fixed number of points if the Seeker never calls the Bluff and the Hider wins. For example, if the Max Odjects for the Game are 3 and Max Attempts are 5, the pay-off for the Hide Player for winning the game might be fixed at 25 points. This requires that the Seeker make 5 incorrect attempts in this case. The pay-off for a Seeker who correctly identifies a Bluff, in contrast, may depend on the number of attempts used by the Seeker before they made the correct Bluff call. A sample pay-off for the Seek Player who correctly called a Bluff could be as follows:
Seek Player uses 4 Attempts: 14 Points
Seek Player uses 3 Attempts: 16 Points
Seek Player uses 2 Attempts: 18 Points
Seek Player uses 1 Attempt: 20 Points

The Seeker may lose their entire turn for making an incorrect Bluff call, or may only be charged for a single incorrect identification attempt against their Max Attempts allotment, depending on the embodiment.

In a further alternative embodiment of the invention, Hiders and Seekers could be able to assign varying point values for different games or hides—increasing or decreasing the stakes of a particular round. For example, a Hider can be allowed to offer a Seeker varying levels of points for winning a particular hide they have created, and to demand an increased number of points in return in the Hider wins. For example, a Hider can offer an award for a particular game, which is higher than standard award, which will be deducted from Hider's current score if the Seeker wins. Alternatively, if the Hider wins, they could receive an increased number of points in return.

### Resources for Implementing the Invention

Persons of skill in the art can implement the disclosed invention using programming techniques well known in the art, and electronic hardware and devices that are already in wide use. Nevertheless, the Applicants suggest the following examples of background resources useful for implementing different aspects and embodiments of the invention. The internet links are provided merely as examples of where such information may be found. Persons of skill in the art will be able to locate similar resources even if these specific links become inactive. The resources and technology available for implementing the invention are expected to evolve and improve over time.

The reference below explains the difference between projective, affine, similarity, and Euclidean transformation. http://homepages.inf.ed.ac.uk/rbf/HIPR2/affine.htm

Further, most currently available operating systems provide a built-in program implementation library for affine transformation, which could be used for implementation of the current invention.

The following reference explains the use of affine transformation with matrix mathematics: http://active.tutsplus.com/tutorials/effects/understanding-affine-transformations-with-matrix-mathematics/

The following reference highlights the library available for implementation of affine transformation on Apple's® iPhone®. Similar libraries and implementations are available for other operating systems: https://developerapple.com/library/mac/#documentation/graphicsimaging/reference/CGAffineTransform/Reference/reference.html

The reference below highlights the use of ImageMagick (an open source library to create and modify images) to perform affine transformation: http://www.imagemagick.org/Usage/distorts/affine/

The following reference highlights the Image Magick extension for PHP (Imagick), which can be used to implement the transformation on a thin client such as a web browser: http://php.net/manual/en/book.imagick.php

The ImageMagick library can be used for other operations such as creating tools for adding shadows, enabling croping, and performing other transformation such as adjusting saturation, adjusting color, and matching histogram.

This game it meant to be played using devices and technology that will evolve, improve, and change over time. The Applicants intend that their invented game can and will be used with hardware, software, interfaces, and communications technology that will be developed in the future, and do not consider their invention limited to the specific devices and technology which exist and are common at the time the game was invented.

While a specific embodiment of the invention has been shown and described in detail to illustrate the application of the principles of the invention, it will be understood that the invention may be embodied otherwise without departing from such principles.

1. A method of playing an electronic pictorial hide-and-seek game between at least two players, the method comprising:
selecting a first player to be a hider and a second player to be a seeker;
the hider, using an electronic device, selecting a picture to be a base image;
providing one or more odjects for use by the hider, wherein each odject comprises an electronic image of at least one item;
the hider selecting from one of bluffing and hiding at least one odject in the base image;
wherein the process of hiding an odject in the base image comprises selecting an odject, positioning the odject on the base image, and adjusting the odject to attempt to conceal the odject within the base image;
wherein bluffing comprises the hider indicating that the hider is declining to hide any odjects in the base image;
the hider indicating that the step of either bluffing or hiding at least one odject in the base image is complete, after which point the base image and any hidden odjects become a resulting game comprising a game image;
displaying the game image to the seeker using an electronic device;
the seeker, using an electronic device, selecting from one of calling a bluff and attempting to identify at least one odject hidden in the game image; and
communicating an outcome of the game to the hider and the seeker.

2. The method of claim 1, the method further comprising:
repeating the step of the seeker selecting from one of calling a bluff and attempting to identify at least one odject hidden in the resulting game until an ending event occurs;
wherein an ending event is one of the seeker calling a bluff, the seeker identifying all odjects hidden in the resulting game within a fixed number of identification attempts, and the seeker using up said fixed number of turns without identifying all odjects hidden in the game image.

3. The method of claim 1, wherein at least one of the hider and the seeker use an electronic device comprising a touch screen to play the game.

4. The method of claim 1, wherein the step of adjusting the odject to attempt to conceal the odject comprises adding shadows to at least one of the base image and the odject.

5. The method of claim 1, wherein the step of adjusting the odject to attempt to conceal the odject comprises at least one of shrinking and enlarging the odject.

6. The method of claim 1, wherein the step of adjusting the odject to attempt to conceal the odject comprises cropping the odject.

7. The method of claim 1, wherein the hider is provided with picture editing tools usable with an electronic device; and
wherein the step of adjusting the odject to attempt to conceal the odject comprises the hider using the picture editing tools on at least one of the base picture and an odject.

8. The method of claim 1, wherein the step of adjusting the odject to attempt to conceal the odject comprises rotating the odject.

9. The method of claim 1, further comprising the hider using an electronic device comprising a digital camera to take a picture, the hider using the same electronic device to play the electronic pictorial hide-and-seek game, and using said picture taken with the digital camera as the base image.

10. The method of claim 1, wherein the hider creates one or more odjects for hiding using an electronic device; and
wherein the hider creates the odject by selecting at least one object in a photograph and turning the selected object into an odject.

11. The method of claim 1, wherein the step of providing one or more odjects for use by the hider comprises providing an electronic page displaying a plurality of odjects for the hider to chose from.

12. The method of claim 1, wherein the game image is displayed on a touch screen, and
wherein the step of the seeker attempting to identify at least one odject hidden in the game image comprises the seeker touching a position on the touch screen that the seeker believes shows an odject.

13. The method of claim 1, wherein at least one player accesses the game using a social networking internet site.

14. The method of claim 1, wherein the first player and the second player each play the game using respective electronic devices;
wherein the game is hosted by a gaming host which is separate from said electronic devices; and
wherein the game is played using a client-server arrangement comprising the gaming host and said at least two electronic devices.

15. The method of claim 1, wherein at least one electronic device is a mobile telephone device comprising a touch screen and a digital camera.

16. The method of claim 1, wherein electronic instructions for running the game are embodied in game logic; and
wherein at least part of the game logic resides on a player's electronic device.

17. The method of claim 1, wherein at least one of the base image and the odjects comprise sponsored advertising content.

18. The method of claim 1, further comprising providing the hider with a base picture and with a set of odjects which are preselected to blend in within a scene depicted by said base picture.

19. A system for playing an electronic pictorial hide-and-seek game between at least two players, the system comprising:
a first hiding electronic device;
the first hiding electronic device being programmed to present a hider player with a base picture, to allow the hider player to select at least one object image, to allow the hider player to place the object image in the base picture, and to adjust at least one of the object image and the base picture so as to conceal the object image within the base picture;
a means for processing the base image and the at least one object image to form a game image; and
a second seeking electronic device;
the second seeking electronic device being programmed to present a seeker player with the game image, to allow the seeking player to select points on the game image where the seeking player believes an object image has been hidden, and to determine if the points selected by the seeker player on the game image correspond to hidden game images.

20. The system of claim 20, wherein the first hiding electronic device comprises a digital camera and a touch screen; and
wherein the system comprises a host which is separate from the first hiding electronic device and the second seeking electronic device, the host comprising a processor and game logic, the host also being adapted for communication with the first and second electronic devices.
